(19) United States
(12) Patent Application Publication
(10) Pub. No.: US 2025/0087208 A1
(43) Pub. Date: Mar. 13, 2025

(54) METHOD AND DEVICE FOR CLASSIFYING UTTERANCE INTENT CONSIDERING CONTEXT SURROUNDING VEHICLE AND DRIVER

(71) Applicants: Hyundai Motor Company, Seoul (KR); Kia Corporation, Seoul (KR)

(72) Inventor: Song Eun LEE, Seongnam-si (KR)

(73) Assignees: Hyundai Motor Company, Seoul (KR); Kia Corporation, Seoul (KR)

(21) Appl. No.: 18/793,044

(22) Filed: Aug. 2, 2024

(30) Foreign Application Priority Data
Sep. 11, 2023 (KR) 10-2023-0120613
Jan. 12, 2024 (KR) 10-2024-0005376

(51) Int. Cl. G10L 15/183; B60R 16/037

(52) U.S. Cl. CPC G10L 15/183; B60R 16/0373

(57) ABSTRACT

In a method and device for classifying the intent of an utterance in consideration of context surrounding a vehicle and a driver, the computer-implemented method for determining an intent of a user's utterance includes obtaining utterance data representing an utterance occurred within a vehicle and context information related to the utterance, generating a prompt based on the utterance data and the context information, obtaining a context-aware sentence from an output of a generative large language model by providing the prompt to the generative large language model, and providing the context-aware sentence to an intent classification model to determine the intent of the utterance.

### CROSS-REFERENCE TO RELATED APPLICATIONS

The present application claims priority to Korean Patent Application Nos. 10-2023-0120613, filed Sep. 11, 2023 and 10-2024-0005376, filed Jan. 12, 2024, the entire contents of which is incorporated herein for all purposes by this reference.

### BACKGROUND OF THE PRESENT DISCLOSURE

### Field of the Present Disclosure

The present disclosure relates to a method and device for classifying the intent of an utterance in consideration of context surrounding a vehicle and a driver.

### Description of Related Art

The content described below simply provides background information related to the present embodiment and does not form related art.

With the advent of software defined vehicles, the importance of voice recognition is growing.

Vehicle voice recognition systems allow a driver to interact with a vehicle through voice commands. The capacity to execute functions within the vehicle through simple voice commands is more than just a luxury and it is a safety and convenience feature that allows drivers to remain focused on the road ahead.

Advances in deep learning have made it possible for voice recognition systems to process natural languages. Nonetheless, voice recognition systems continue to face one persistent challenge, since drivers often use short, truncated or unclear words when using voice recognition systems, making it difficult to understand real intents of drivers and to relate the same into specific infotainment or driving-related functions.

Conventional voice recognition systems significantly rely on single utterances, which has the problem of being insufficient to capture subtle intents of drivers.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

According to an exemplary embodiment of the present disclosure, a large language model may be used to obtain a context-enriched sentence from an ambiguous utterance of a user and vehicle context information, and the intent for the ambiguous utterance may be determined based on the context-enriched sentence.

The objects to be achieved as an exemplary embodiment of the present disclosure are not limited to the objects mentioned above, and other objects that are not mentioned may be clearly understood by those skilled in the art from the description below.

Various aspects of the present disclosure are directed to providing a computer-implemented method for determining an intent of a user's utterance including obtaining utterance data representing an utterance occurred within a vehicle and context information related to the utterance, generating a prompt based on the utterance data and the context information, the prompt including a task description, a function inventory, guided learning examples, the context information, and the utterance data, obtaining a context-aware sentence from an output of a generative large language model by providing the prompt to the generative large language model, and providing the context-aware sentence to an intent classification model to determine the intent of the utterance.

According to another exemplary embodiment of the present disclosure, the present disclosure provides a computing device including at least one processor and a memory operatively coupled to the at least one processor, wherein the memory stores instructions that cause the at least one processor to perform operations in response to an execution of the instructions by the at least one processor, and wherein the operations including obtaining utterance data representing an utterance occurred within a vehicle and context information related to the utterance, generating a prompt based on the utterance data and the context information, the prompt including a task description, a function inventory, guided learning examples, the context information, and the utterance data, obtaining a context-aware sentence from an output of a generative large language model by providing the prompt to the generative large language model, and providing the context-aware sentence to an intent classification model to determine the intent of the utterance.

According to another exemplary embodiment of the present disclosure, the present disclosure provides a non-transitory computer-readable recording medium in which instructions are stored, the instructions causing a computer to perform, when executed by the computer, obtaining utterance data representing an utterance occurred within a vehicle and context information related to the utterance, generating a prompt based on the utterance data and the context information, the prompt including a task description, a function inventory, guided learning examples, the context information, and the utterance data, obtaining a context-aware sentence from an output of a generative large language model by providing the prompt to the generative large language model, and providing the context-aware sentence to an intent classification model to determine the intent of the utterance.

According to an exemplary embodiment of the present disclosure, it is possible to improve the accuracy of intent classification for an utterance without additional training on the intent classification model by utilizing a large scale language model.

According to an exemplary embodiment of the present disclosure, it is possible to improve usability of the voice recognition function by accurately determining the intent of an utterance by considering not only the utterance but also vehicle context information.

The effects of the present disclosure are not limited to the effects mentioned above, and other effects not mentioned will be clearly understood by those skilled in the art from the description below.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a framework for determining the intent of an utterance of a user in consideration of context according to an exemplary embodiment of the present disclosure.

FIG. 2A, FIG. 2B and FIG. 2C are exemplary diagrams for explaining a process of obtaining a context-aware sentence according to an exemplary embodiment of the present disclosure.

FIG. 3 is a flowchart of a method for determining the intent of a user's utterance according to an exemplary embodiment of the present disclosure.

FIG. 4 is a block diagram illustrating an example of a computing device according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In the following description, like reference numerals preferably designate like elements, although the elements are shown in different drawings. Furthermore, for clarity and for brevity, the following description of various exemplary embodiments will omit a detailed description of related known components and functions when considered obscuring the subject of the present disclosure.

Various ordinal numbers or alpha codes such as first, second, i), ii), a), b), etc., are prefixed solely to differentiate one component from the other but not to imply or suggest the substances, order, or sequence of the components. Throughout the present specification, when a part “includes” or “comprises” a component, the part is meant to further include other components, to not exclude thereof unless specifically stated to the contrary. The terms such as “unit,” “module,” and the like refer to units in which at least one function or operation is processed and they may be implemented by hardware, software, or a combination thereof.

The description of the present disclosure to be presented below in conjunction with the accompanying drawings is intended to describe exemplary embodiments of the present disclosure and is not intended to represent the only embodiments in which the technical idea of the present disclosure may be practiced.

As used herein, the term “utterance data” refers to text data converted from a voice command of a user through a voice recognition module, that is, a speech-to-text (STT)) module.

As used herein, the term “ambiguous utterance data” refers to utterance data by which the user's intent cannot be determined using only the utterance data because the utterance is short, incomplete or unclear.

Large Language Model (LLM) is an advanced type of language model which is trained using deep learning technology on massive amounts of text data. LLMs includes a causal language model that generates human-like text by predicting subsequent words based on the context provided by previous words, a masked language model that predicts blank words based on the context provided by preceding and following words, etc. This is achieved by employing advanced deep learning techniques such as transformer architectures and attention mechanisms, which allow the model to capture intricate relationships between words and the context in which the words are used.

One of the key advantages of LLMs is the ability to reason and generate knowledge about the human world. This is not because LLMs inherently understand the world or have experiences, but because they have been trained on a vast corpus of human-generated text data. Since these text data encapsulate a wide range of human knowledge, culture, and reasoning processes, LLMs can generate outputs that mimic human-like understanding and reasoning by learning patterns within these data.

Furthermore, another unique characteristic of LLMs is their ability to perform in-context learning. Unlike traditional machine learning models that require a separate training phase, LLMs can adjust predictions based on the context provided in a conversation or sequence of interactions. Therefore, LLMs are well-suited for tasks such as zero-shot, one-shot, and few-shot learning, where the model is expected to perform based on a single example or a few examples, respectively.

In the context of LLMs, prompt engineering is a crucial aspect that needs to be considered. Prompt engineering refers to the crafting initial inputs, that is, prompts, to guide a model towards generating a desired output. As LLMs become larger and more complex, prompt engineering becomes more important. It has been observed that the same model can produce vastly different outputs based on the prompt, making it a crucial aspect of achieving a desired performance. In fact, in the field of prompt engineering, various studies focusing on strategies for eliciting the most effective responses from LLMs have gained significant attention recently.

The present disclosure relates to a technology for determining a user's intent even when an ambiguous utterance is input to a vehicle voice recognition system by combining the ambiguous utterance and vehicle context information to generate a prompt, providing the prompt to LLMs to obtain context-enriched sentences as output, and determining the user's intent based on the context-enriched sentences.

The present disclosure utilizes a reasoning function of LLMs to generate comprehensive and coherent sentences based on in-vehicle specific prompts. The present disclosure provides an alternative to traditional encoder-based intent classification models which often suffer from short and truncated sentences by use of LLMs to generate context-enrich sentences (hereinafter referred to as “context-aware sentences”). Accordingly, it is possible to accurately determine the intent of an ambiguous utterance.

The large language model used in an exemplary embodiment of the present disclosure is a language model trained with a large amount of data and may refer to a generative language model that can properly perform a task when only a few-shot sample is provided. In other words, the large language model is an auto regressive model and can refer to a language model configured for reasoning without fine-tuning using a method such as few-shot learning. Compared to existing general language models, the large language model can have 10 times more parameters (for example, more than 100 billion parameters). The large language model used in an exemplary embodiment of the present disclosure may include, for example, Generative Pre-trained Transformer 3 (GPT-3) or the like, but is not limited thereto.

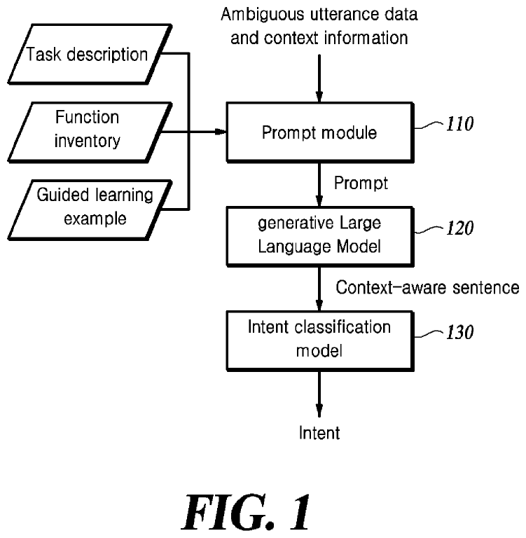

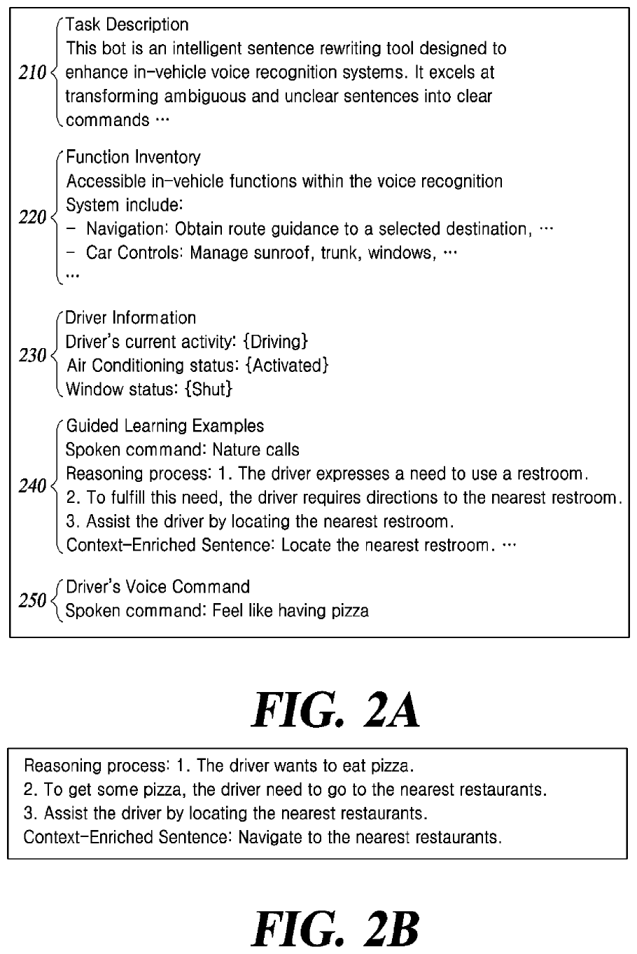

FIG. 1 illustrates a framework for determining the intent of a user's utterance in consideration of context according to an exemplary embodiment of the present disclosure. FIG. 2A, FIG. 2B and FIG. 2C are exemplary diagrams for explaining a process of obtaining a context-aware sentence according to an exemplary embodiment of the present disclosure.

The process of determining the intent of a user's utterance in consideration of context according to an exemplary embodiment of the present disclosure may be performed in a server of a vehicle voice recognition system, which will be described in detail with reference to FIG. 1 and FIG. 2A-2C.

Referring to FIG. 1, a prompt module 110 generates structured input, that is, prompt, for a generative large language model 120. The prompt provides a structured set of instructions to the generative large language model 120, guiding the generative large language model 120 to extrapolate a hidden intent behind an ambiguous utterance and subsequently produce a corresponding context-enriched sentence.

The primary components of the prompt include a task description 210, function inventory 220, context information 230, guided learning examples 240, and user utterance data 250. A personalized prompt may be generated according to user utterance data and context information. An example of the prompt is shown in FIG. 2A.

The task description 210 describes tasks that the generative large language model 120 may perform. This corresponds to a set of guidelines that show the role of the generative large language model 120 and help the generative large language model 120 understand its mission. The task description 210 may be previously stored in a database or the like, and the database or the like may be referenced to when the prompt module 110 generates prompts.

The function inventory 220 enumerates the range of in-vehicle functions which may be accessed through the vehicle voice recognition system. This provides a clear idea of the range of commands available to the generative large language model 120 and assists the vehicle voice recognition system in providing the function that best matches a user utterance among various in-vehicle functions. The function inventory 220 may be previously stored in a database or the like, and the database or the like may be referenced to when the prompt module 110 generates prompts.

The vehicle voice recognition system can manage a plurality of intent classes which may be classified based on functional similarities or domains, and examples of some of these functional domains are shown in Table 1. The descriptions of functional domains not only serve as intent classes, but may also be used to form the function inventory for the input prompt of the generative large language model 120.

TABLE 1

| Domain | Description |
|---|---|
| Navi | Route planning and POI discovery. |
| | Find the nearest points of |
| | interest or add waypoints. |
| Vehicle | Control sunroof, trunk, windows, |
| | steering wheel heater, port and seat |
| | heating/cooling setting, temperature, |
| | airflow, air conditioning, and |
| | circulation of the vehicle. |
| Settings | Adjust vehicle/infotainment system preferences. |
| Cluster | Access information about the |
| | vehicle's cluster system such as |
| | speed, engine RPM, fuel efficiency, and mileage. |
| Portal | General internet search such as news, |
| | stock prices, sports, entertainment. |
| Music | Music search and playback. |
| Weather | Check current weather conditions. |
| Embedded | Operate radio and infotainment apps. |
| QA | Answer car-related queries. |
| BT | Phone connectivity functions such as Bluetooth |
| | pairing and unpairing with smartphones. |
| Agent | Casual conversation with the bot. |
| AVNT | Control sound volume. |
| ThirdParty | Access to third-party apps. |
| Others | Cover functions outside the specified domains. |

The context information 230 provides important information related to the situation surrounding the driver and the vehicle. The context information 230 provides important details about the situation or environment surrounding the vehicle and the driver, and assists the generative large language model 120 in understanding an utterance in light of the driver's specific situation. The context information 230 may include vehicle status information. Here, the vehicle status information may include, but is not limited to, driving information of the vehicle, operating statuses of in-vehicle devices, various setting information, and information on previous utterances of the user. Here, the operating statuses of the in-vehicle devices may include, but is not limited to, data regarding operations of the in-vehicle devices, such as navigation operation, radio operation, air conditioner operation, heater operation, and heating/seat operation of the user, for example. The context information 230 collected from the vehicle may be transmitted to the server of the vehicle voice recognition system using a wireless communication network.

The guided learning examples 240 contribute to training the generative large language model 120 through a process known as few-shot learning. The guided learning examples 240 may include examples demonstrating a reasoning process for understanding a user's real intent and uncovering any hidden intents behind utterances. The guided learning examples 240 also provide guidelines for constructing appropriate sentences that accurately capture an intended meaning of an utterance. In-context learning through guided learning examples 240 can especially improve the proficiency of the model in understanding ambiguous or unclear utterances.

The guided learning examples 240 may include example utterance data, example context-aware sentences, and example processes of reasoning example context-aware sentences from the example utterance data.

According to another exemplary embodiment of the present disclosure, the guided learning examples 240 may include example utterance data and example context-aware sentences.

The user utterance data 250 is text converted from user voice commands through a voice recognition module, that is, an STT module. The voice recognition module may be provided in the vehicle or included in the server of the voice recognition system. When the voice recognition module is provided in the vehicle, utterance data may be transmitted to the server of the voice recognition system using a wireless communication network. In the process in which the generative large language model 120 reasons a context-aware sentence corresponding to the user utterance data 250, the task description 210, function inventory 220, context information 230, and guided learning examples 240 described above are utilized.

The generated prompt is input into the generative large language model 120 to obtain output data generated including context-aware sentences. This process efficiently converts ambiguous utterance data into clear and practicable sentences, contributing to a more intuitive and effective vehicle voice recognition system. An example of output data generated by the generative large language model 120 is shown in FIG. 2B. The output data may be generated in the format of the guided learning examples 240, as shown in FIG. 2B.

Context-aware sentences are obtained from the output data. This is for extracting only context-aware sentences to be provided to the intent classification model 130 from the output data because the output data includes context-aware sentences and reasoning processes. FIG. 2C shows an example of a context-aware sentence extracted from the output data.

The obtained context-aware sentence is provided to the intent classification model 130 to determine the intent of the utterance. An encoder-based intent classification model (e.g., Electra or the like) may be utilized to ensure robustness in selecting an intent from a set of predefined classes. The intent classification model 130 may be trained on domain-specific datasets related to the vehicle and specifically designed for intent classification tasks. Since the limitations of ambiguous utterances have been appropriately addressed in the previous process of obtaining context-aware sentences, the intent classification model 130 can classify intents with minimal additional training. by classifying accurate intent using context-aware sentences rather than ambiguous utterance data, the overall efficiency of the vehicle voice recognition system may be improved.

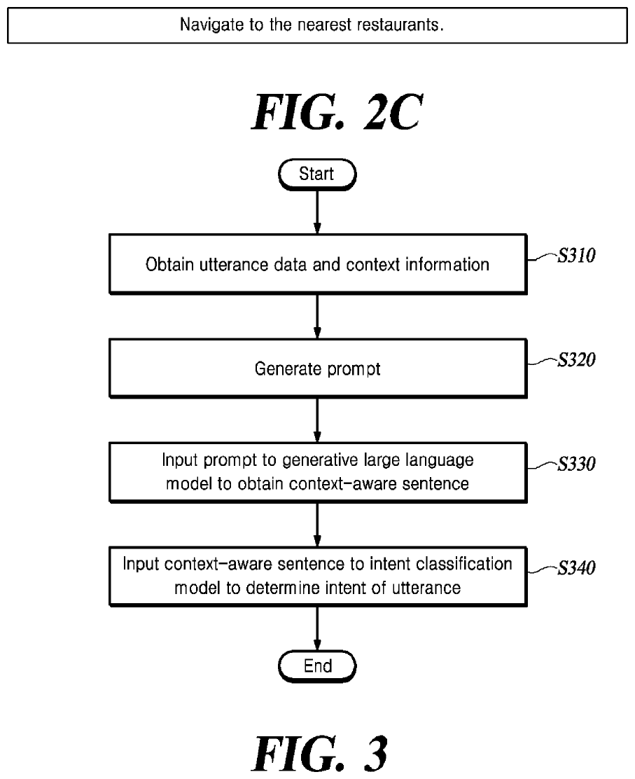

FIG. 3 is a flowchart of a method for determining the intent of a user's utterance according to an exemplary embodiment of the present disclosure. The method may be performed in the server of the vehicle voice recognition system.

Referring to FIG. 3, the method receives, at one or more input devices (e.g., a microphone), an utterance from an in-vehicle user. The method obtains utterance data representing an utterance and context information related to the utterance (S310). The utterance data may refer to text data converted from a user's utterance through a voice recognition module (e.g., a speech-to-text module).

According to another exemplary embodiment of the present disclosure, a process of determining whether the utterance data is ambiguous may be additionally performed in process S310. That is, first, the method obtains utterance data, and provides the utterance data to the intent classification model 130 to determine the intent of the utterance. If the intent classification model 130 fails to determine the intent of the utterance, the method obtains context information related to the utterance.

The method generates a prompt corresponding to the utterance data and the context information (S320). The prompt includes a task description, function inventory, guided learning examples, the context information, and the utterance data.

The method provides the prompt to the generative large language model 120 to obtain a context-aware sentence from the output of the generative large language model (S330).

The method provides the context-aware sentence to the intent classification model to determine the intent of the utterance based on the output of the intent classification model (S340).

The method may generate responsive data including the intent of the utterance and an in-vehicle function corresponding thereto, in response that the intent of the utterance is determined. The responsive data may be at least one of audio data, image data, or text data. The method may output, at one or more output devices (e.g., a speaker, a display), the responsive data to the user, and perform the corresponding in-vehicle function based on the confirmation response from the user.

Examples in which the technology disclosed in the present specification may be used include cases where the object of a user utterance is unclear, cases of indirect speech, cases of utterances of idiomatic expressions, etc. For example, if the user utters “Turn it off”, the air conditioner in the vehicle is turned on, the gear shifting is in D, the driver's window is closed, and the radio receiver is turned off, the intent of the user may be predicted by reconstructing a context-aware sentence as “Turn off the air conditioner”. For example, if the user utters “Turn it on”, the air conditioner in the vehicle is turned on, the gear shifting is in D, the driver's window is closed, and the radio receiver is turned off, the intent of the user may be predicted by reconstructing a context-aware sentence as “Turn on the radio”. For example, as shown in FIGS. 2A-2C, when the user utters “I want to eat pizza”, the intent of the user may be predicted by reconstructing a context-aware sentence as “navigate to the nearest restaurant” with reference to the function inventory 220, the context information 230, and the guided learning examples 240.

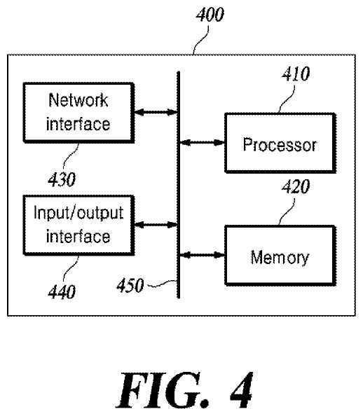

FIG. 4 is a block diagram illustrating an example of a computing device according to an exemplary embodiment of the present disclosure. The method for determining the intent of a user's utterance according to various exemplary embodiments of the present disclosure may be implemented by the computing device 400 shown in FIG. 4.

As shown in FIG. 4, the computing device 400 may include at least one processor 410, a memory 420, a network interface 430, and an input/output interface 440. A bus 450 provides a mechanism for allowing components of the computing device 400 to communicate with each other as intended. Although the bus 450 is schematically shown as a single bus, alternative implementations may use a plurality of buses.

The processor 410 may be configured to process instructions of a computer program by performing basic arithmetic, logic, and input/output operations. Instructions may be provided to the processor 410 through the memory 420 or the network interface 430. For example, the processor 410 may be configured to execute received instructions according to program codes stored in a recording device such as the memory 420.

The memory 420 is a computer-readable recording medium, and may include a random access memory (RAM) and permanent mass storage devices such as a read only memory (ROM) or a disk drive. Here, permanent mass recording devices such as a disk drive may be included in the computing device 400 as separate permanent storage devices separate from the memory 420.

Additionally, an operating system and at least one program code may be stored in the memory 420. Such software components may be loaded into the memory 420 from a computer-readable recording medium separate from the memory 420. Such separate computer-readable recording media may include computer-readable recording media such as floppy drives, disks, tapes, DVD/CD-ROM drives, and memory cards. In another exemplary embodiment of the present disclosure, software components may be loaded into the memory 420 through the network interface 430 rather than a computer-readable recording medium. For example, software components may be loaded into the memory 420 of the computing device 400 based on a computer program provided by files received through the network interface 430.

The network interface 430 may provide a function for the computing device 400 to communicate with other external devices (e.g., a terminal including a voice recognition module provided in a vehicle, etc.) through a wired or wireless communication network. For example, requests, instructions, data, files, and the like generated by the processor 410 of the computing device 400 according to the program code stored in a recording device such as the memory 420 may be transmitted to other external devices through a wired or wireless communication network under the control of the network interface 430. Conversely, signals, instructions, data, files, and the like may be transmitted from other external devices to the computing device 400 through the network interface 430 of the computing device 400 via a wired or wireless communication network. Signals, instructions, data, and the like received through the network interface 430 may be transmitted to the processor 410 or the memory 420, and files and the like may be stored in a storage medium (the aforementioned permanent storage device) which may be additionally included in the computing device 400.

The input/output interface 440 may be a means for interfacing with input/output devices. For example, input devices may include devices such as a microphone, a keyboard, and mouse, and output devices may include devices such as a display and a speaker. As an exemplary embodiment of the present disclosure, the input/output interface 440 may be a means for interfacing with a device in which input and output functions are integrated, such as a touchscreen. The input/output devices may be integrated with the computing device 400.

Additionally, in other exemplary embodiments of the present disclosure, the computing device 400 may include fewer or more components than those shown in FIG. 4. For example, the computing device 400 may be implemented to include at least some of the above-described input/output devices or may further include other components such as a transceiver, a database, etc.

The apparatus or method according to an exemplary embodiment of the present disclosure may include the respective components arranged to be implemented as hardware or software, or hardware and software combined. Additionally, each component may be functionally implemented by software, and a microprocessor may execute the function by software for each component when implemented.

Various illustrative implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations may include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a processor. The computer programs (which are also known as programs, software, software applications, or code) include instructions for a programmable processor and are stored in a “computer-readable recording medium.”

The computer-readable recording medium includes any type of recording device on which data that can be read by a computer system are recordable. Examples of computer-readable recording mediums include non-volatile or non-transitory media such as a ROM, CD-ROM, magnetic tape, floppy disk, memory card, hard disk, optical/magnetic disk, storage devices, and the like. The computer-readable recording mediums may further include transitory media such as a data transmission medium. Furthermore, the computer-readable recording medium can be distributed in computer systems connected via a network, wherein the computer-readable codes may be stored and executed in a distributed mode.

Although the steps in the respective flowcharts are described to be sequentially performed, they merely instantiate the technical idea of various exemplary embodiments of the present disclosure. Therefore, a person including ordinary skill in the pertinent art could perform the steps by changing the sequences described in the respective flowcharts or by performing two or more of the steps in parallel, and hence the steps in the respective flowcharts are not limited to the illustrated chronological sequences.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A computer-implemented method for determining an intent of a user's utterance, the method comprising:
obtaining, by a processor, utterance data representing an utterance occurred within a vehicle and context information related to the utterance;
generating, by the processor, a prompt based on the utterance data and the context information, the prompt including a task description, a function inventory, guided learning examples, the context information, and the utterance data;
obtaining, by the processor, a context-aware sentence from an output of a generative large language model by providing the prompt to the generative large language model; and
providing, by the processor, the context-aware sentence to an intent classification model to determine the intent of the utterance.

2. The method of claim 1, wherein the obtaining of the utterance data representing the utterance and the context information related to the utterance includes:
obtaining the utterance data;
providing the utterance data to the intent classification model to determine the intent of the utterance; and
obtaining the context information related to the utterance in response to failing to determine the intent of the utterance.

3. The method of claim 1, wherein the context information includes status information of the vehicle.

4. The method of claim 1, wherein the function inventory includes at least one in-vehicle function accessible through a vehicle voice recognition system.

5. The method of claim 1, wherein the guided learning examples include example utterance data, an example context-aware sentence, and an example process of reasoning the example context-aware sentence from the example utterance data.

6. The method of claim 1, wherein the guided learning examples include example utterance data and an example context-aware sentence.

7. A computing apparatus comprising:
at least one processor; and
a memory operably coupled to the at least one processor,
wherein the memory stores instructions for causing the at least one processor to perform operations in response to instructions executed by the at least one processor,
the operations including:
obtaining utterance data representing an utterance occurred within a vehicle and context information related to the utterance;
generating a prompt based on the utterance data and the context information, the prompt including a task description, a function inventory, guided learning examples, the context information, and the utterance data;
obtaining a context-aware sentence from an output of a generative language model by providing the prompt to the generative language model; and
providing the context-aware sentence to an intent classification model to determine the intent of the utterance.

8. The computing apparatus of claim 7, wherein the obtaining of the utterance data representing the utterance and the context information related to the utterance includes:
obtaining the utterance data;
providing the utterance data to the intent classification model to determine the intent of the utterance; and
obtaining the context information related to the utterance upon failing to determine the intent of the utterance.

9. The computing apparatus of claim 7, wherein the context information includes status information of a vehicle.

10. The computing apparatus of claim 7, wherein the function inventory includes at least one in-vehicle function accessible through a vehicle voice recognition system.

11. The computing apparatus of claim 7, wherein the guided learning examples include example utterance data, an example context-aware sentence, and an example process of reasoning the example context-aware sentence from the example utterance data.

12. The computing apparatus of claim 7, wherein the guided learning examples include example utterance data and an example context-aware sentence.

13. A non-transitory computer-readable recording medium in which instructions are stored, the instructions causing a computer including a processor to perform, when executed by the computer:
obtaining utterance data representing an utterance occurred within a vehicle and context information related to the utterance;
generating a prompt based on the utterance data and the context information, the prompt including a task description, a function inventory, guided learning examples, the context information, and the utterance data;
obtaining a context-aware sentence from an output of a generative language model by providing the prompt to the generative language model; and
providing the context-aware sentence to an intent classification model to determine the intent of the utterance.

14. The non-transitory computer-readable recording medium of claim 13, wherein the obtaining of the utterance data representing the utterance and the context information related to the utterance includes:
obtaining the utterance data;
providing the utterance data to the intent classification model to determine the intent of the utterance; and
obtaining the context information related to the utterance in response to failing to determine the intent of the utterance.

15. The non-transitory computer-readable recording medium of claim 13, wherein the context information includes status information of the vehicle.

16. The non-transitory computer-readable recording medium of claim 13, wherein the function inventory includes at least one in-vehicle function accessible through a vehicle voice recognition system.

17. The non-transitory computer-readable recording medium of claim 13, wherein the guided learning examples include example utterance data, an example context-aware sentence, and an example process of reasoning the example context-aware sentence from the example utterance data.

18. The non-transitory computer-readable recording medium of claim 13, wherein the guided learning examples include example utterance data and an example context-aware sentence.
